(19) United States
(12) Patent Application Publication
(10) Pub. No.: US 2020/0326925 A1
(43) Pub. Date: Oct. 15, 2020

(54) MEMORY DEVICE FIRMWARE UPDATE AND ACTIVATION WITH MEMORY ACCESS QUIESCENCE

(71) Applicant: Intel Corporation, Santa Clara, CA (US)

(72) Inventors: Murugasamy K. NACHIMUTHU, Beaverton, OR (US); Mohan J. KUMAR, Aloha, OR (US); Tiffany J. KASANICKY, Longmont, CO (US); Christopher HESS, Chandler, AZ (US); Sarathy JAYAKUMAR, Portland, OR (US); Daniel K. OSAWA, Tigard, OR (US); Maciej PLUCINSKI, Hillsboro, OR (US); Krzysztof RUSOCKI, Ciechocinek (PL); Jason M. BILLS, Beaverton, OR (US)

(21) Appl. No.: 16/913,819

(22) Filed: Jun. 26, 2020

(51) Int. Cl. G06F 8/65

(52) U.S. Cl. CPC G06F 8/65

(57) ABSTRACT

Examples include updating firmware for a persistent memory module in a computing system during runtime. Examples include downloading firmware to the persistent memory module; saving settings of one or more input/output (I/O) devices of the computing system and setting a timeout value of the one or more I/O devices to greater than a time to activate the firmware in the persistent memory module. Examples include updating the firmware in the persistent memory module during runtime of the computing system by quiescing access to one or more memory modules of the computing system; sending a request to the persistent memory module to activate the firmware; waiting for the request to activate the firmware to be completed by the persistent memory module; and un-quiescing access to the one or more memory modules of the computing system; and restoring the saved settings for the one or more I/O devices.

### BACKGROUND

The field of invention relates generally to updating firmware in memory modules in computer systems, and, more specifically, to updating and activating firmware in memory modules with primary memory access quiescence.

Three-dimensional (3D) cross-point memory (3D XPoint) (also called persistent memory (PMEM)) is a byte-addressable, write-in-place non-volatile memory (NVM) technology commercially available from Intel® Corporation as Optane™ and from Micron Corporation as QuantX™ memory, which may be packaged in a persistent memory module, for example, a Data Center Persistent Memory Module (DCPMM) (Optane™ DC Persistent Memory). DCPMM provides persistent memory and volatile memory and, in conjunction with processor technologies, a persistent memory system can support multiple memory modes such as one level memory (1LM), Memory Mode (MM), App-Direct and App-Direct-Write-Back. Users of 3D) (Point products in computer server systems (such as cloud service providers (CSPs)) would like to upgrade firmware in persistent memory modules to apply bug fixes, apply workarounds, and add telemetry to debug and/or determine root cause issues, without rebooting the computer server systems to reduce service interruptions to meet Service Level Agreements (SLAs) with their end customers. In an earlier generation of persistent memory technology, the computer server system was required to be rebooted in order to upgrade the firmware in persistent memory modules. This resulted in system downtime, which in many cases is unacceptable. In a succeeding generation of persistent memory technology, a runtime firmware upgrade capability is provided that does not require rebooting the server system. This persistent memory technology requires memory access to be quiesced for a period of time (e.g., 300 milliseconds, 500 milliseconds, etc.) to activate the new firmware in a persistent memory module. However, in contemporary computer server systems, Peripheral Component Interconnect express (PCIe) devices are typically configured with a PCIe completion timeout (PCIe CTO) of 50 microseconds (usec) to 50 msec. Quiescing memory access for a longer period of time during a runtime firmware upgrade in a persistent memory module results in a PCIe I/O device completion timeout and operating system (OS) service timeout. These errors negatively impact system performance.

### BRIEF DESCRIPTION OF THE DRAWINGS

FIG. 1 illustrates an example computing system according to some embodiments.

FIG. 2 illustrates an example computing system according to some embodiments.

FIG. 3 is a diagram illustrating persistent memory module firmware upgrade interfaces according to some embodiments.

FIG. 4 is a flow diagram of OS processing according to some embodiments.

FIG. 5 is a flow diagram of persistent memory module firmware update processing according to an embodiment.

FIG. 6 is a flow diagram of persistent memory module firmware update processing according to another embodiment.

FIG. 7 is a flow diagram of OS processing according to some embodiments.

FIG. 8 is a flow diagram of basic input/output system (BIOS) processing according to some embodiments.

FIG. 9 is a flow diagram of baseboard management controller (BMC) processing according to some embodiments.

FIG. 10 is a flow diagram of management engine (ME) processing according to some embodiments.

FIG. 11 is a flow diagram of I/O device processing according to some embodiments.

FIG. 12 illustrates an example of a storage medium.

FIG. 13 illustrates an example computing platform.

### DETAILED DESCRIPTION

In order to overcome these timeout problems, embodiments of the present invention comprise a computing system wherein platform firmware (such as the basic input/output system (BIOS), baseboard management controller (BMC), management engine-server platform services (ME-SPS)) and the OS co-ordinate the upgrade of persistent memory module firmware. Embodiments of the present invention provide a mechanism for platform firmware and the OS to upgrade persistent memory module firmware without a system reset and without incurring I/O device completion timeouts. This enables CSPs to deploy runtime firmware upgrades in their server systems without reboots, resulting in improved quality of service (QoS) by fixing bugs, installing workarounds, managing reliability, availability and serviceability (RAS) solutions, and enabling better debugging operations and root cause determinations in persistent memory devices.

In one embodiment, platform firmware (e.g., BIOS (which may be compliant with the Unified Extensible Firmware Interface (UEFI) Specification v2.8A, February 2020, or predecessor or successor versions)) publishes persistent memory module firmware upgrade capability information to the OS along with an estimated firmware activation time including processor and I/O quiesce time. Once the new firmware for a persistent memory module is written to the persistent memory module, the OS prepares for an estimated processor and I/O quiesce timeout (in some embodiments either the OS manages the I/O device quiesce state or platform firmware manages the I/O device quiesce state) and calls the platform firmware to activate the new firmware in the persistent memory module. After the platform firmware completes the activation of the persistent memory modules, the OS restores services (e.g., reevaluating interrupts, reevaluating timers and restarting I/O services, etc.) to continue server system operation.

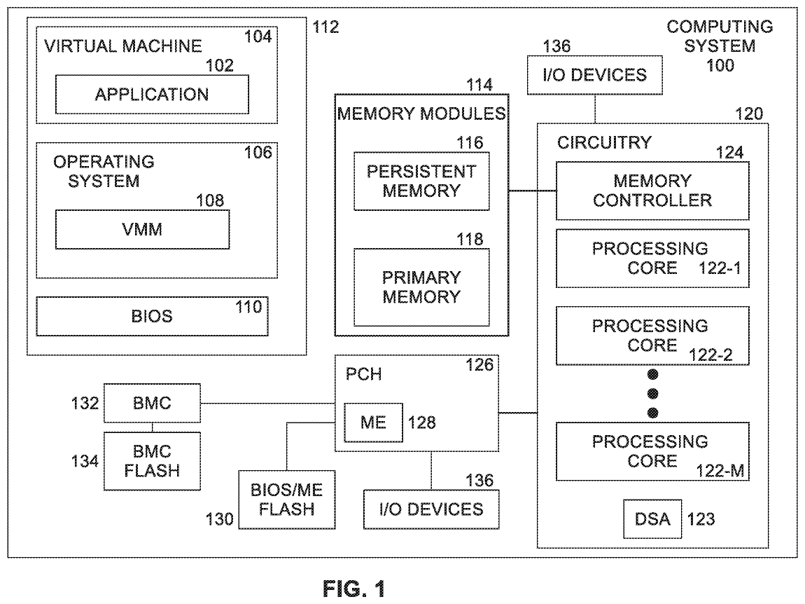

FIG. 1 illustrates an example computing system 100. According to some examples, computing system 100 includes circuitry 120, memory modules 114 including one or more primary memory modules 118 and one or more persistent memory modules 116 coupled to circuitry 120, and a platform control hub (PCH) 126. PCH 126 includes management engine (ME) 128 (such as ME-SPS) and is coupled to BMC 132 (which in turn is coupled to BMC flash memory 134), BIOS/ME flash memory 130, and one or more I/O devices 136. In some embodiments, I/O devices 136 are coupled to circuitry 120 and these I/O devices may read data from and write data to memory devices 114 without using PCH 126.

Computing system 100 includes software being executed such as operating system (OS) 106, virtual machine manager (VMM) (also known as a hypervisor) 108, at least one application 102 (running in a virtual machine (VM) 104 in one embodiment). In one embodiment, OS 106 is any variant of Linux™. In another embodiment, OS 106 is Windows® Server. Other OSs may also be used (e.g., Apache hypertext transport protocol (HTTP) server available from the Apache Software Foundation, etc.). OS 106 interacts with BIOS 110.

In at least one embodiment, I/O devices 136 may be one or more of hard disk drives (HDDs) and/or solid-state drives (SSDs). In an embodiment, I/O devices 136 include non-volatile memories (NVMs). In some examples, circuitry 120 may communicatively couple to other system components via a PCIe bus (not shown) conforming to version 3.0 or other versions of the PCIe standard published by the PCI Special Interest Group (PCI-SIG). In some examples, OS 106, VMM 108, VM 104, and application 102 are implemented, at least in part, via cooperation between one or more memory modules 114 (including persistent memory module 116 and/or primary memory module 118), I/O devices 136 (whether coupled to PCH 126 or circuitry 120), and elements of circuitry 120 such as memory controller 124 and processing cores 122-1 to 122-m, where “m” is any positive whole integer greater than 2. In an embodiment, OS 106, VMM 108, VM 104 and application 102 are executed by one or more processing cores 122-1 to 122-m.

In some examples, computing system 100, includes but is not limited to a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, a system-on-a-chip (SoC), or a combination thereof. In one example, computing system 100 is a disaggregated server. A disaggregated server is a server that breaks up components and resources into subsystems (e.g., network sleds). Disaggregated servers can be adapted to changing storage or compute loads as needed without replacing or disrupting an entire server for an extended period of time. A server could, for example, be broken into modular compute, I/O, power and storage modules that can be shared among other nearby servers.

Circuitry 120 having memory controller 124 and processing cores 122-1 to 122-m may include various commercially available processors, including without limitation, Intel® Atom®, Celeron®, Core (2) Duo®, Core i3, Core i5, Core i7, Itanium®, Pentium®, Xeon® or Xeon Phi® processors, ARM processors, processors from Applied Micro Devices (AMD) Incorporated, and similar processors. In one embodiment, circuitry 120 includes only one processing core. In an embodiment, circuitry 120 includes driver and support assistance (DSA) engine 123. In an embodiment, processing cores 122 include support for memory traffic quiesce and BMC 132 to initiate quiesce and un-quiesce operations through out-of-band (00B) access mechanisms (e.g., I²C or platform environment control interface (PECI)).

According to some examples, primary memory module 118 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In another embodiment, primary memory module 118 may include one or more hard disk drives within and/or accessible by computing platform 101.

In an embodiment, persistent memory module 116 is a byte-addressable non-volatile memory (NVM). Non-volatile types of memory may include byte or block addressable types of non-volatile memory having a 3D XPoint memory structure that includes chalcogenide phase change material (e.g., chalcogenide glass). Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In an embodiment, persistent memory modules provide OOB (e.g., I²C or PECI) access to activate firmware while all primary memory traffic is quiesced.

In an embodiment, parameters in I/O devices 136 may be set such that access to persistent memory module 116 by I/O devices 136 may be stopped or I/O device timeouts may be dynamically changed so that a timeout does not occur within persistent memory module 116 firmware activation time. In some cases, access to persistent memory module 116 may not be stopped without stopping access to primary memory module 118. For example, if memory mode (MM) is used, access to the primary memory module 118 may evict the data from the primary memory, which will result in persistent memory module 116 being accessed by circuitry 120 or if application 102 is written such that the application uses part of primary memory and part of persistent memory, circuitry 120 may not be able to selectively stop the access.

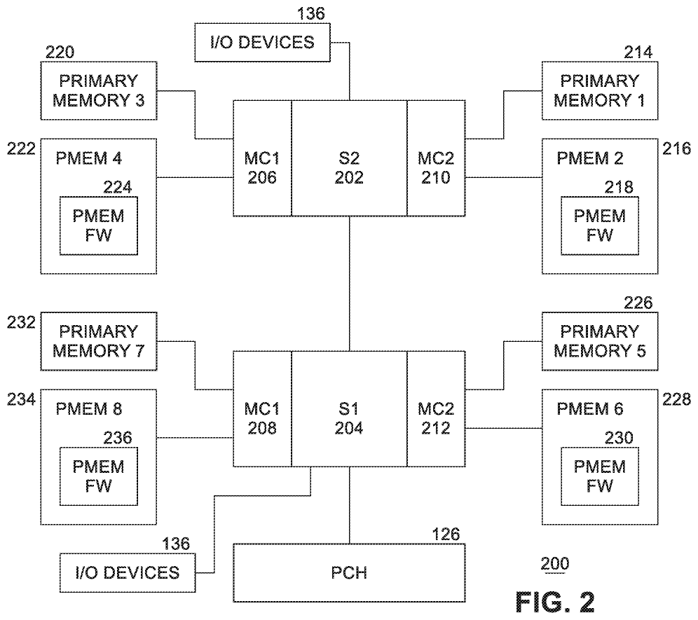

FIG. 2 illustrates example computing system 200 according to some embodiments. In this example, computing system 200 includes two processor sockets S1 204 and S2 202, although in other examples other numbers of processor sockets may be used. Socket S2 202 is coupled to two memory controllers MC1 206 and MC2 210, and zero or more I/O devices 136. MC2 210 is coupled to at least one primary memory 1 214 and at least one persistent memory module (PMEM) 2 216. PMEM 2 216 includes PMEM FW 218. Similarly, MC1 206 is coupled to at least one primary memory module 3 220 and at least one PMEM 4 222. PMEM 4 222 includes PMEM FW 224. Socket S1 204 is coupled to two memory controllers MC1 208 and MC2 211, zero or more I/O devices 136, and PCH 126. MC2 212 is coupled to at least one primary memory module 5 226 and at least one PMEM 6 228. PMEM 6 228 includes PMEM FW 230. Similarly, MC1 208 is coupled to at least one primary memory module 7 232 and at least one PMEM 8 234. PMEM 8 234 includes PMEM FW 236. In one embodiment, PMEM FW 218, PMEM FW 224, PMEM FW 230, and PMEM FW 236 are identical. In one embodiment, MC1 206 and MC1 208 are identical. In one embodiment MC2 210 and MC2 212 are identical. In other embodiments, other numbers of memory controllers, primary memory modules, sockets, channels, persistent memory modules, memory controllers per socket, channels per memory controller, and memories per channel may be used. In another embodiment, one or more memory controllers are resident on an I/O device.

Access to the memory modules (including primary memory modules 214, 220, 226, and 232 and persistent memory modules 216, 222, 228, and 234) may be interleaved between these memory modules or may be operated without interleaving. In some embodiments, one or more memory modules act as caching memory for other memory modules. In one embodiment, each persistent memory module (such as PMEM 2 216, PMEME 4 222, PMEM 6 228, and/or PMEM 8 234) includes a persistent memory module controller (not shown) with PMEM FW that supports memory link initialization, error handling, power failure handling, persistent memory accesses, wear leveling, read/write disturb, self-monitoring, analysis, and reporting technology (SMART) information, security management, telemetry, RAS handling, etc.

When PMEM FW in a persistent memory module needs to be upgraded without rebooting computing system 200, the memory traffic to the persistent memory module (and primary memory modules in some cases) needs to be quiesced to allow performance of functions such as new firmware security authentication, saving the current state of the persistent memory module so that the new firmware can safely transition to that state after the upgrade, and handling runtime operations during the transition from old firmware to new firmware including: errors, power failure, wear leveling, read/write disturb, SMART, etc.

However, persistent memory modules 116 may be accessed by processor cores 122 or I/O devices 136 which may not support the timeout needed by the persistent memory modules to upgrade the PMEM FW. For example, as shown in Tables 7-30 and 7-31 from the PCIe Base Specification Revision 5.0, Version 1.0, dated May 28, 2019, available on the Internet at pcisig.com*specifications (“/” has been replaced by “*” to deter live links), some memory modules may not support a PCIe completion timeout, resulting in operation only in a default 50 microsecond to 50 millisecond range, some memory modules may support only a PCIe Completion Timeout (CTO) range specified as A and B, and/or some memory modules may support all ranges. Even if memory modules support all specified ranges ABCD, OS 106 may have configured the memory modules (such as persistent memory modules 116) to operate in a default range or in range A. In this case, for example, if the memory module traffic needs to be quiesced for a 500 milliseconds time period, this will cause timeout errors, resulting in system errors. In some cases, processor cores 122 may not support memory traffic quiesce during runtime.

Embodiments of the present invention provide a mechanism to deal with I/O, processor and OS support scenarios and the capability to upgrade the PMEM FW at run time without reboot and no or minimal service impact.

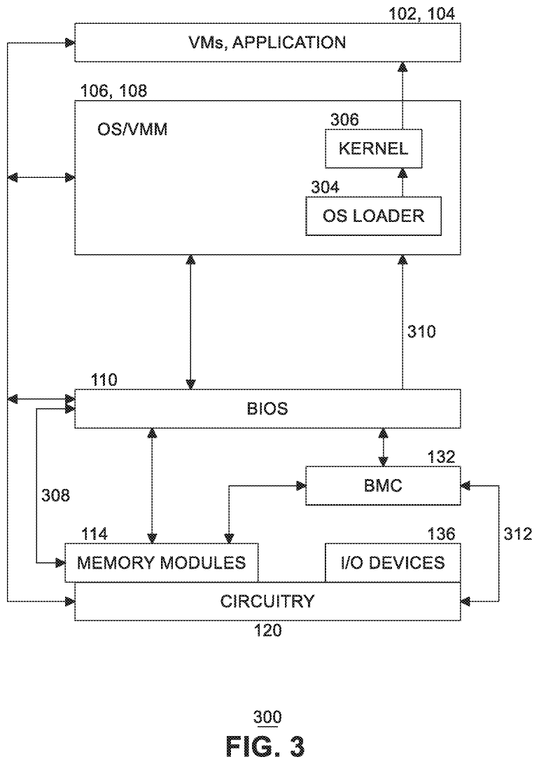

FIG. 3 is a diagram 300 illustrating persistent memory module firmware upgrade interfaces according to some embodiments. VMs 104 and application 102 interact with OS 106 and VMM 108. OS 106 includes OS loader 304 and kernel 306. OS 106 and VMM 108 interact with BIOS 110. BIOS 110 interacts with memory modules 114 and BMC 132. Processing cores 122 are coupled with memory modules 114 and I/O devices 136. In an embodiment, memory modules 114 provide an interface 308 for platform firmware (BIOS 110 and/or BMC 132) and OS 106 to determine the capabilities of the memory modules including estimated memory quiesce time/activation time requirements and a mechanism to activate the firmware (PMEM FW) in persistent memory modules 116. In an embodiment, BIOS 110 provides an interface 310 (such as Advanced Configuration and Power Interface (ACPI) device specific methods (DSMs), an ACPI Platform Communication Channel (PCC), or through a Unified Extensible Firmware Interface (UEFI) runtime service interface) for OS 106 to upgrade the firmware in persistent memory modules 116 including a platform firmware support capability to support PMEM FW activation, estimated activation time, processor and I/O quiesce time and activation of the updated PMEM FW. In an embodiment, BMC 132 provides an interface 312 to circuitry 120 (including memory controller 124 and processing cores 122) to perform memory traffic quiesce and activate the PMEM FW while access to persistent memory module 116 is quiesced.

Based on memory module interface 308 and BIOS interface 310, OS 106 determines platform and firmware capabilities, loads PMEM FW on persistent memory modules 116, prepares itself for the estimated memory access interruption and calls BIOS 110 to activate the PMEM FW if the BIOS can manage pausing I/O device timeouts. Otherwise, the OS prepares I/O devices 136 to stop all direct memory access (DMA) and calls the BIOS to activate the PMEM FW.

If the OS enables Direct Device Access (DDA) devices to VMs, the OS may not have the ability to pause I/O devices 136 without VM 104 knowing about the I/O access interruptions. When an OS with DDA enabled is used, CSPs typically require activation of PMEM FW without notifying the VMs. Hence PCIe completion timeout handling in BIOS 110 is necessary if the I/O devices are capable of supporting a PCIe completion timeout that is more than a quiesce timeout in persistent memory modules 116 needed to activate the PMEM FW. If the OS does not enable DDA, the OS may implement an I/O device DMA pausing mechanism. In both cases, execution by processor cores 122 accessing memory modules 114 during PMEM FW activation need to be paused. But when the persistent memory access is quiesced, even the system management mode (SMM) invoked by a system management interrupt (SMI) cannot be run. One reason is that even if the SMI code/data are cached, by the time quiesce is invoked Direct Cache Access (DCA) could evict SMI code/data from a processor cache resulting in a system error. Embodiments of the present invention overcomes this disadvantage.

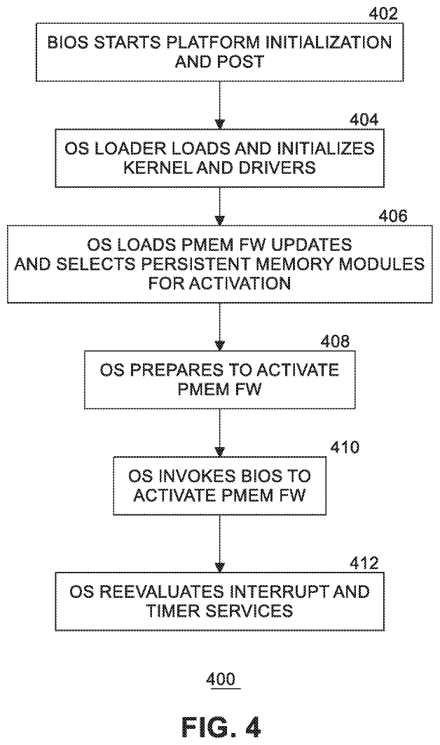

FIG. 4 is a flow diagram 400 of OS processing according to some embodiments. At block 402, OS 106 starts platform initialization and power-on self-test (POST). At block 404, OS loader 304 loads and initializes kernel 306 and drivers. Blocks 406 through 412 are performed during PMEM FW update and activation. At block 406, the OS loads PMEM FW updates and selects persistent memory modules 118 for activation (e.g., with the updated PMEM FW). In one embodiment, a user invokes an OS utility including or pointing to the PMEM FW image. In another embodiment, a life cycle management agent gets the PMEM FW image from a life cycle management service and invokes OS services to update the PMEM FW. In another embodiment, a life cycle management service in BMC 132 communicates with the persistent memory module through an out-of-band (00B) interface, stages the PMEM FW and invokes an OS service to activate the PMEM FW. At block 408, OS 106 prepares to activate the PMEM FW by saving I/O device settings and setting I/O devices to a timeout greater than the PMEM FW activation time or stopping DMA to the persistent memory module (when the I/O device timeout does not need to be changed). At block 410, in one embodiment the OS invokes BIOS 110 to activate the PMEM FW. In another embodiment, the OS communicates directly with the persistent memory module to activate the PMEM FW. At block 412, the OS reevaluates interrupt and timer services.

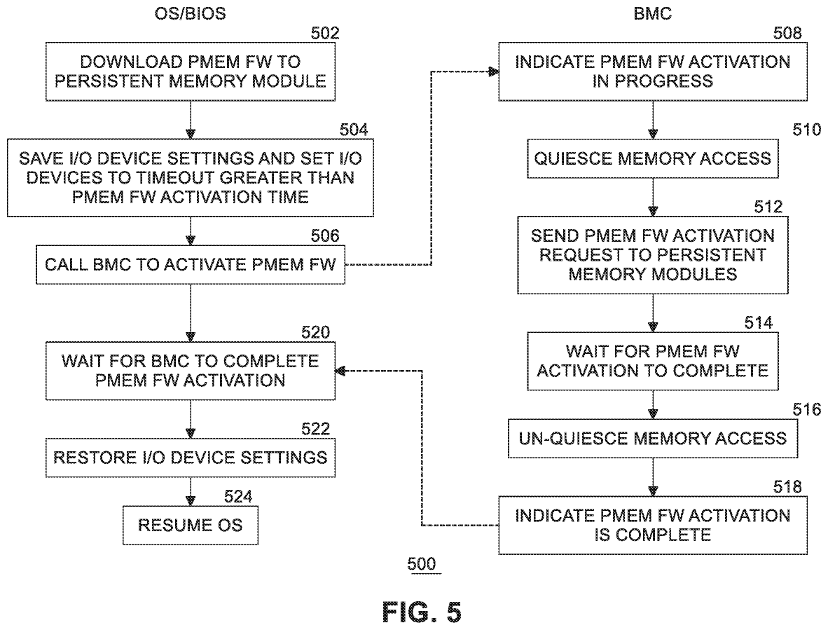

FIG. 5 is a flow diagram 500 of persistent memory module firmware (PMEM FW) update processing according to an embodiment. In this embodiment, BMC 132 initiates quiesce and communicates with a persistent memory module 116 to activate PMEM FW during runtime of the computing system. This embodiment requires enabling and activation of PMEM FW updates by the BMC. At block 502, OS 106 and/or BIOS 110 (in one embodiment, the OS can download the PMEM FW image; in another embodiment the BIOS can download the PMEM FW image; in yet another embodiment, BMC 132 can download the PMEM FW image) downloads the PMEM FW to a flash memory in one or more persistent memory modules 116. At block 504, OS 106 and/or BIOS 110 saves settings of I/O devices 136 and sets the timeout of the I/O devices to a value greater than the PMEM FW activation time. At block 506, OS 106 and/or BIOS 110 calls BMC 132 to activate the new (e.g., updated) PMEM FW. OS 106 and/or BIOS 110 then starts polling the BMC for a status change. At block 508, BMC 132 indicates that PMEM FW activation is in progress. At block 510, BMC quiesces access to memory modules 114. In some situations, if the persistent memory is used not in conjunction with primary memory module 118 and if no I/O devices are using the persistent memory, it is sufficient to quiesce only the persistent memory (primary memory quiesce is not required in this case). In one embodiment, only persistent memory is quiesced. In another embodiment, both persistent memory and primary memory are quiesced. At this point, OS 106 and/or BIOS 110 cannot access memory modules 114 and are stalled.

At block 512, BMC sends a PMEM FW activation request to persistent memory modules 116 through an out-of-bound (00B) access mechanism. Once the PMEM FW activation request is submitted by the BMC, persistent memory modules 116 start the PMEM FW activation process. At block 514, the BMC waits for the PMEM FW activation to complete. When the persistent memory module completes activation, the persistent memory module updates the activation status and the BMC receives the updated status. At block 516, once PMEM FW activation is complete, BMC 132 un-quiesces access to memory modules 114. In one embodiment, only persistent memory is un-quiesced. In another embodiment, both persistent memory and primary memory are un-quiesced. OS 106 and/or BIOS 110 can now resume execution. At block 518, BMC indicates that PMEM FW activation is complete. BMC 132 returns to OS 106 and/or BIOS 110. At block 520, OS 106 and/or BIOS 110 have been waiting for BMC 132 to complete PMEM FW activation. OS 106 and/or BIOS 110 return to restore processing. At block 522, OS 106 and/or BIOS 110 restore I/O device settings. At block 524, OS 106 resumes processing.

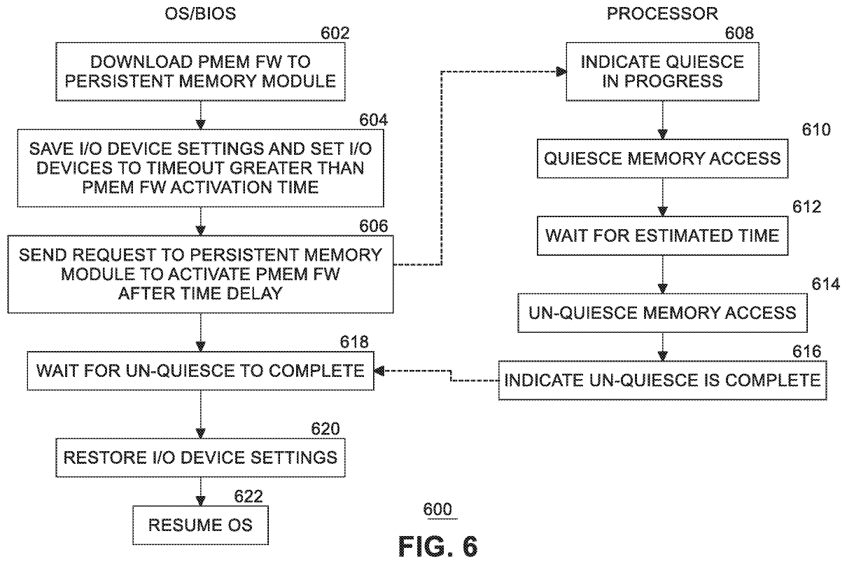

FIG. 6 is a flow diagram 600 of persistent memory module firmware (PMEM FW) update processing according to another embodiment. In this embodiment, OS 106 and/or BIOS 110 activate the PMEM FW update during runtime of the computing system without use of BMC 132. At block 602, OS 106 and/or BIOS 110 downloads the PMEM FW to a flash memory in one or more persistent memory modules 116. At block 604, OS 106 and/or BIOS 110 saves settings of I/O devices 136 and sets the timeout of the I/O devices to a value greater than the PMEM FW activation time. At block 606, OS 106 and/or BIOS 110 sends a request to persistent memory module 116 to activate PMEM FW after a time delay between when a command is sent to the persistent memory module to start activation and when the persistent memory module actually starts the activation process. The persistent memory module starts a timer, waits for the timeout to occur, and then starts PMEM FW activation. At block 608, processor circuitry 120 indicates that quiesce is in progress. In one embodiment, a microcontroller in the processor circuitry executes processor microcode which provides a model specific register (MSR) interface in which the OS/BIOS could call an MSR to quiesce the computer system for a pre-determined amount of time. In one embodiment, 608 and 616 could be implemented in the same block, where the BIOS/OS sets the MSR bit to start the quiesce operation and the same bit is polled by BIOS/OS until clear. The processor clears the bit once the un-quiesce is completed. At block 610, processor circuitry 120 quiesces access to memory modules 114. In some situations, if the persistent memory is used not in conjunction with primary memory 118 and if no I/O devices are using the persistent memory, it is sufficient to quiesce only the persistent memory (primary memory quiesce is not required in this case). In one embodiment, only persistent memory is quiesced. In another embodiment, both persistent memory and primary memory are quiesced. At this point, OS 106 and/or BIOS 110 cannot access memory modules 114 and are stalled.

At block 612, processor circuitry 120 waits for an estimated time for PMEM FW activation plus the time delay. When the estimated time expires, processor circuitry 120 un-quiesces access to memory modules 114 at block 614. In one embodiment, only persistent memory is un-quiesced. In another embodiment, both persistent memory and primary memory are un-quiesced. OS 106 and/or BIOS 110 can now resume execution. At block 616, processor circuitry 120 indicates that un-quiesce is complete. Control returns to OS 106 and/or BIOS 110. At block 618, OS 106 and/or BIOS 110 have been waiting for processor circuitry 120 to un-quiesce the memory modules. OS 106 and/or BIOS 110 return to restore processing. At block 620, OS 106 and/or BIOS 110 restore I/O device settings. At block 622, OS 106 resumes processing.

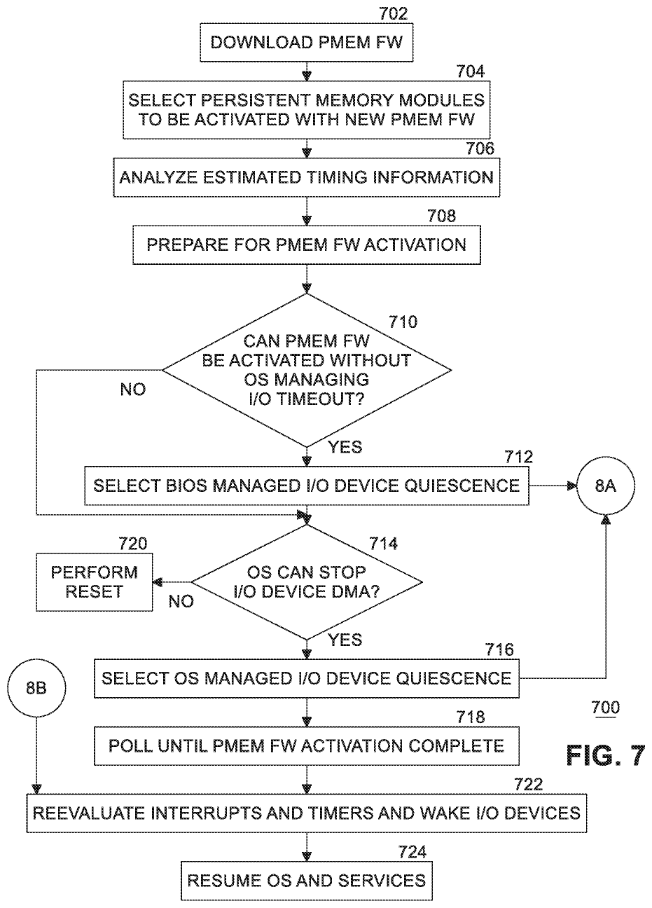

FIG. 7 is a flow diagram 700 of OS processing according to some embodiments. At block 702, OS 106 downloads PMEM FW from a lifecycle management agent to a persistent memory module 116. At block 704, the OS selects persistent memory modules 116 to be activated with the new (e.g., updated) PMEM FW. At block 706, the OS analyzes estimated timing information for activating the PMEM FW. At block 708, OS 106 prepares for PMEM FW activation. In an embodiment, OS preparation includes informing any critical services that the computing system is quiesced for an estimated time, flushing any persistent memory markers, and if any OS services are waiting for interrupts or timers within the estimated activation time, ensuring that they are paused, and resuming to a handler when the FW activation completed.

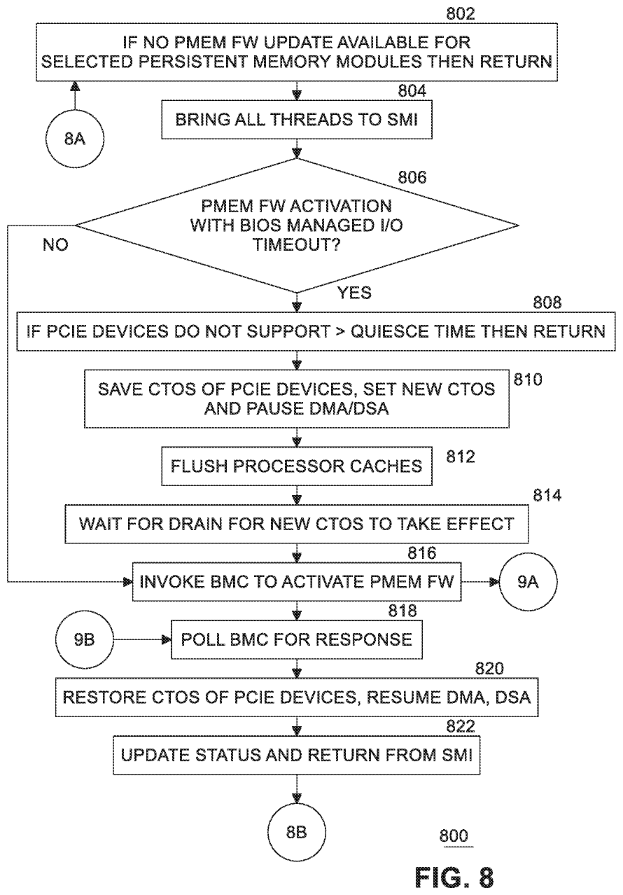

At block 710, if the PMEM FW can be activated without the OS 106 managing the I/O timeouts, then processing continues to block 712, where the OS selects BIOS managed I/O quiescence and processing control goes to block 802 of FIG. 8 via connector 8A. Otherwise, processing continues with block 714. At block 714, if the OS can stop I/O device DMA, then processing continues with block 716. If the OS cannot stop I/O device DMA, then processing continues with block 720, where a system reset is performed. If reboot time is critical, a warm reset or a memory preserving warm reset is performed to activate the new PMEM FW. Otherwise, a cold reset is performed to activate the new PMEM FW. At block 716 (the path where the OS can stop I/O device DMA), the OS selects OS managed I/O device quiescence. OS 106 calls BIOS 110 to perform processing on FIG. 8 via connector 8A. OS processing continues at block 718, where the OS polls until the persistent memory module being updated with new PMEM FW has completed PMEM FW activation. At block 722, the OS reevaluates interrupts and timers and wakes up I/O devices 136. In one embodiment, if the OS uses a software timer interrupt, it is possible the timer interrupts might be missed, and the OS may need to sync the timers back to a system time (e.g., wall clock). At block 724, the OS resumes OS operations and services.

FIG. 8 is a flow diagram 800 of BIOS processing according to some embodiments. At block 802, if no PMEM FW update is available for selected persistent memory modules then return to the OS (this is an error condition). At block 804, BIOS 110 brings all processing threads (e.g., on processor cores 122) to an SMI state. This brings all processors to a SMI rendezvous, resulting in a stall of OS code execution by processor cores 122 but I/O access to I/O devices 136 is still in progress. At block 806, if PMEM FW activation is being performed with the BIOS managing I/O timeouts, then processing continues with block 808. If not (e.g., OS is managing I/O timeouts), then processing continues with block 816. At block 808, in an embodiment, if all PCIe devices of computing system 100 (e.g., memory modules 114, I/O devices 136, or other processor/chipset integrated devices such as micro controller, management engine (ME), acceleration assistance engines performing cryptographic operations and/or encryption/description assistance, sometimes referred to as Driver & Support Assistance (DSA) engine 123) do not support a completion timeout (CTO) that is greater than the persistent memory module access quiesce time required to activate the PMEM FW (for example, 500 milliseconds), then return to the OS (this is an error condition). At block 810, the BIOS saves existing CTOs of PCIe devices (for example, a default value of 50 milliseconds or range A of Table 7-30), sets new CTOs to new values, such as one second (e.g., the upper range C of Table 7-30), and pauses DMA and/or data streaming accelerator (DSA) engine processing. In one embodiment, if the existing CTO is not greater than the PMEM FW activation time, then the new CTO is set to a value greater than the PMEM FW activation time plus the drain wait time of block 814 below. At block 812, the BIOS flushes caches of processor cores 122 to evict any existing persistent memory module contents to reach a memory module domain. One reason for flushing caches is to evict the cache contents which might have modified persistent memory contents. For any reason if the power to the computing system or to the memory module is lost (or even a catastrophic error happens) during the PMEM FW activation, flushing the contents to the memory module makes sure the data is not lost.

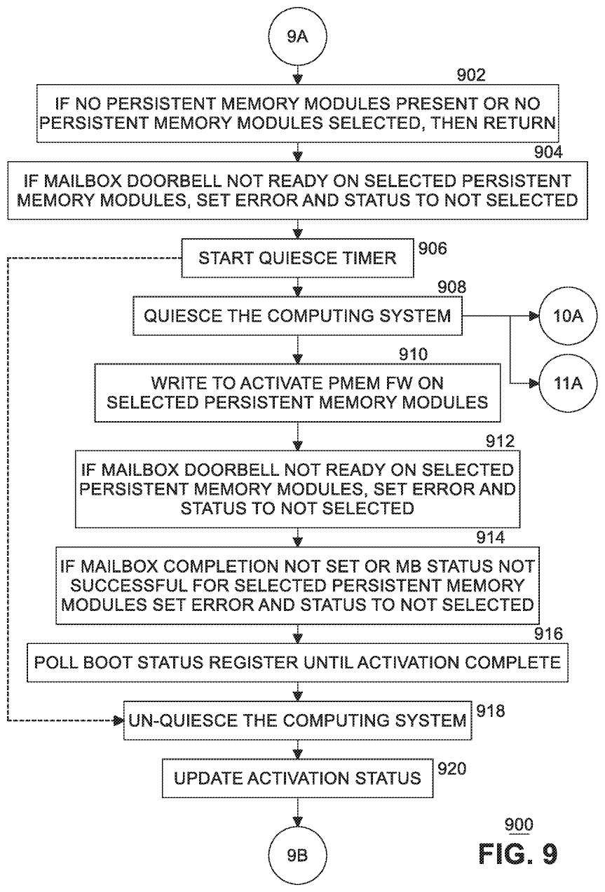

BIOS 110 at block 814 then waits for the currently programmed CTO drain time for new CTOs to take effect. This results in new PCIe transactions being tagged to use the new PCIe CTO settings. At block 816, the BIOS invokes BMC 132 to quiesce and activate the PMEM FW on selected persistent memory modules 118. This step avoids the SMI running out of memory and/or cache during quiesce time. BMC processing continues with block 902 on FIG. 9 via connector 9A. BIOS 110 polls for a response from BMC 132 at block 818. Once BMC 132 returns to BIOS 110 at connector 9B and block 818, the BIOS restores the saved CTOs of PCIe devices and resumes DMA and/or DSA. At block 822, the BIOS updates status and returns from the SMI. Processing returns to the OS at block 722 on FIG. 7 via connector 8B.

FIG. 9 is a flow diagram 900 of BMC processing according to some embodiments. At block 902, BMC 132 checks if no persistent memory modules 116 are present in the computing system or if no persistent memory modules are selected for a PMEM FW update, then return to the BIOS at block 818 of FIG. 8. At block 904, if a mailbox doorbell is not ready on selected persistent memory modules, then BMC 132 sets an error and status to not selected for those persistent memory modules. At block 906, BMC 132 starts a quiesce timer. At block 908, BMC 132 quiesces the computing system 100. In an embodiment, BMC 132 communicates with processor cores 122 to perform memory quiesce through serial protocol I²C, I³C, platform environment control interface (PECI), management component transport protocol (MCTP) or other proprietary mechanism. This effectively stalls the SMI code execution if the SMI code/data are not in a cache of processor cores 122. In other embodiments, a computing system may be running without SMI. In that case, OS 106 can perform the SMI work and communicate with BMC 132 to activate the PMEM FW.

At block 910, BMC communicates with the selected persistent memory modules (e.g., writes a control bit) to activate the new PMEM FW. In an embodiment, this communication is performed using serial protocol I²C, I³C, PECI, MCTP or other proprietary mechanism. At block 912, if the mailbox doorbell is not ready on selected persistent memory modules, set an error and status to not selected. At block 914 if a mailbox completion status is not set or mailbox status is not successful for the selected persistent memory modules, set an error and status to not selected. At block 916, BMC 132 waits for PMEM FW activation completion by polling a boot status register (BSR) until activation of PMEM FW is complete. If PMEM FW activation fails within the allocated quiesce time, BMC declares a PMEM FW activation error. At block 918, BMC 132 un-quiesces the computing system. At block 920, BMC updates the activation status of selected persistent memory modules and control returns to BIOS 110 at block 818 on FIG. 8 via connector 9B.

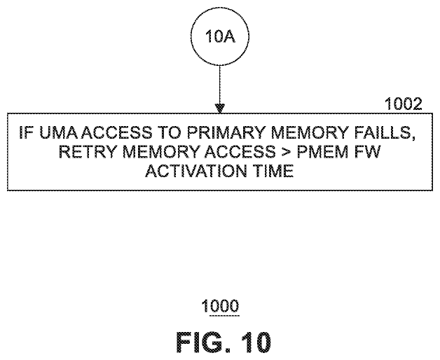

FIG. 10 is a flow diagram 1000 of ME 128 processing according to some embodiments. At block 1002, ME 128 determines if unified memory access (UMA) by the ME to primary memory module 118 fails, then retry memory access for more than the PMEM FW activation time (300 milliseconds in one example). In an embodiment, this step is performed instead of performing a global reset of the computing system or declaring an UMA access failure.

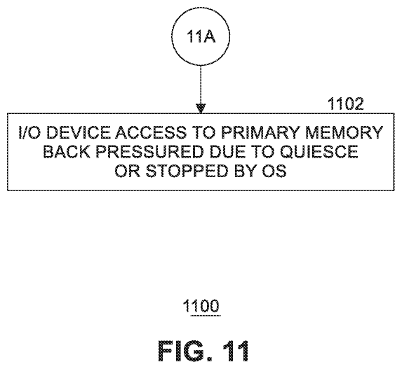

FIG. 11 is a flow diagram 1100 of I/O device 136 processing according to some embodiments. At block 1102, access by I/O devices 136 to primary memory module 118 is back pressured due to the BMC quiesce or stopped by OS 106. As used herein, “backpressured” mean that onces the memory access is quiesced, the I/O devices will not get additional credits from processor sockets to send new memory access requests. Hence any new memory access request coming into the I/O device will remain stuck in its I/O queue, causing delays in sending new requests.

In another embodiment, OS 106 pauses access by I/O devices 136 to primary memory module 118. In this embodiment, block 710 (saving CTOs of PCIe devices, setting new CTOs, and pausing DMA/DSA is not required by SMI/BIOS since the OS already paused the accesses by the I/O devices to primary memory 118.

In addition, if any other microcontrollers (such as ME-SPS/BMC) accesses primary memory module 118 during the quiesce time period, these microcontrollers need to either stop using the primary memory during the quiesce time period or need to implement a safe recovery mechanism, such as retrying the memory access that executes the during the quiesce time period. For example, a ME-SPS 128 DMA engine may still default to 50 milliseconds and access will return an error and the ME-SPS needs to retry the primary memory access rather than causing global reset or declaring an error within the quiesce time period.

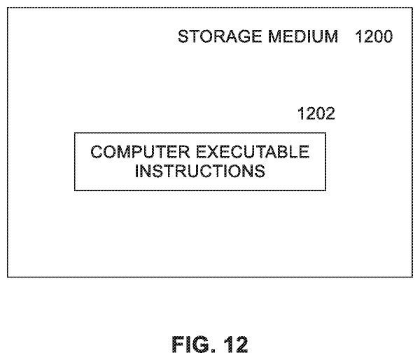

FIG. 12 illustrates an example of a tangible storage medium 1200. Storage medium 1200 may comprise an article of manufacture. In some examples, storage medium 1200 may include any non-transitory computer readable medium or machine readable medium, such as an optical, magnetic or semiconductor storage. Storage medium 1200 may store various types of computer executable instructions, such as instructions 1202 to implement logic flows described above. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

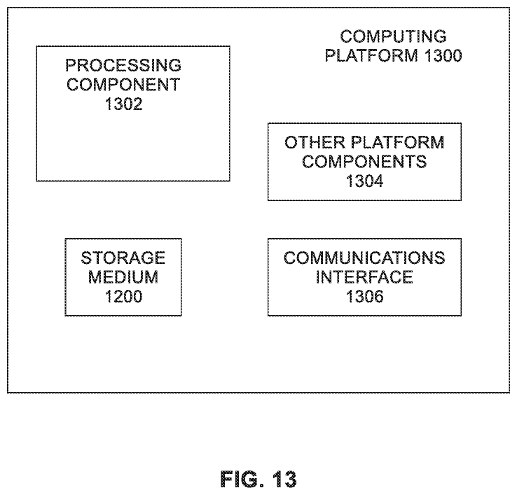

FIG. 13 illustrates an example computing platform 1300. In some examples, as shown in FIG. 13, computing platform 1300 may include a processing component 1302, other platform components 1304 and/or a communications interface 1306.

According to some examples, processing component 1302 may execute processing operations or logic for instructions stored on storage medium 1200. Processing component 1302 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chipsets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1304 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1306 may include logic and/or features to support a communication interface. For these examples, communications interface 1306 may include one or more communication interfaces that operate according to various communication protocols or standards to communicate over direct or network communication links or channels. Direct communications may occur via use of communication protocols or standards described in one or more industry standards (including progenies and variants) such as those associated with the peripheral component interconnect express (PCIe) specification. Network communications may occur via use of communication protocols or standards such those described in one or more Ethernet standards promulgated by the Institute of Electrical and Electronics Engineers (IEEE). For example, one such Ethernet standard may include IEEE 802.3. Network communication may also occur according to one or more OpenFlow specifications such as the OpenFlow Switch Specification.

The components and features of computing platform 1300, including logic represented by the instructions stored on storage medium 1200 may be implemented using any combination of discrete circuitry, ASICs, logic gates and/or single chip architectures. Further, the features of computing platform 1300 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1300 shown in the block diagram of FIG. 13 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of updating firmware for a persistent memory module in a computing system comprising:
downloading firmware to the persistent memory module;
saving settings of one or more input/output (I/O) devices of the computing system and setting a timeout value of the one or more I/O devices to greater than a time to activate the firmware in the persistent memory module;
updating the firmware in the persistent memory module during runtime of the computing system by
quiescing access to one or more memory modules of the computing system;
sending a request to the persistent memory module to activate the firmware;
waiting for the request to activate the firmware to be completed by the persistent memory module; and
un-quiescing access to the one or more memory modules of the computing system; and
restoring the saved settings for the one or more I/O devices.

2. The method of claim 1, comprising:
calling a baseboard management controller (BMC) to update the firmware in the persistent memory module; and
waiting for the BMC to complete updating the firmware in the persistent memory module.

3. The method of claim 2, comprising:
indicating that activation of the firmware in the persistent memory module is in progress prior to quiescing access to the one or more memory modules of the computing system; and
indicating that activation of the firmware in the persistent memory module is complete after un-quiescing access to the one or more memory modules of the computing system.

4. The method of claim 1, comprising:
resuming operation of an operating system (OS) of the computing system after restoring the saved settings of the one or more I/O devices.

5. The method of claim 1, wherein quiescing access to one or more memory modules of the computing system comprises quiescing access to one or more persistent memory modules of the computing system and un-quiescing access to the one or more memory modules of the computing system comprises un-quiescing access to the one or more persistent memory modules of the computing system.

6. The method of claim 1, wherein quiescing access to one or more memory modules of the computing system comprises quiescing access to one or more persistent memory modules and one or more primary memory modules of the computing system and unquiescing access to the one or more memory modules of the computing system comprises un-quiescing access to the one or more persistent memory modules and the one or more primary memory modules of the computing system.

7. At least one tangible machine-readable non-transitory medium comprising a plurality of instructions that in response to being executed by a processor cause the processor to:
download firmware to a persistent memory module;
save settings of one or more input/output (I/O) devices of a computing system and setting a timeout value of the one or more I/O devices to greater than a time to activate the firmware in the persistent memory module;
update the firmware in the persistent memory module during runtime of the computing system by
quiescing access to one or more memory modules of the computing system;
sending a request to the persistent memory module to activate the firmware;
waiting for the request to activate the firmware to be completed by the persistent memory module; and
un-quiescing access to the one or more memory modules of the computing system; and
restore the saved settings for the one or more I/O devices.

8. The at least one tangible machine-readable non-transitory medium of claim 7, comprising a plurality of instructions that in response to being executed by the processor cause the processor to:
call a baseboard management controller (BMC) to update the firmware in the persistent memory module; and
wait for the BMC to complete updating the firmware in the persistent memory module.

9. The at least one tangible machine-readable non-transitory medium of claim 8, comprising a plurality of instructions that in response to being executed by the processor cause the processor to:
indicate that activation of the firmware in the persistent memory module is in progress prior to quiescing access to the one or more memory modules of the computing system; and
indicate that activation of the firmware in the persistent memory module is complete after un-quiescing access to the one or more memory modules of the computing system.

10. The at least one tangible machine-readable non-transitory medium of claim 7, comprising a plurality of instructions that in response to being executed by the processor cause the processor to:
resume operation of an operating system (OS) of the computing system after restoring the saved settings of the one or more I/O devices.

11. A computing system comprising:
a persistent memory module;
a basic input/output system (BIOS);
a baseboard management controller (BMC);
an operating system (OS);
wherein one of the BIOS and the OS is to
download firmware to the persistent memory module;
save settings of one or more input/output (I/O) modules of the computing system and set a timeout value of the one or more I/O devices to greater than a time to activate the firmware in the persistent memory module; and
restore the saved settings for the one or more I/O devices; and
wherein the BMC is to update the firmware in the persistent memory module during runtime of the computing system by
quiescing access to one or more memory modules of the computing system;
sending a request to the persistent memory module to activate the firmware;
waiting for the request to activate the firmware to be completed by the persistent memory module; and
un-quiescing access to the one or more memory modules of the computing system.

12. The computing system of claim 11, wherein the one of the BIOS and the OS is to call the BMC to update the firmware in the persistent memory module; and wait for the BMC to complete updating the firmware in the persistent memory module before restoring the settings for the one or more I/O devices.

13. The computing system of claim 12, wherein the BMC is to indicate that activation of the firmware in the persistent memory module is in progress prior to quiescing access to the one or more memory modules of the computing system; and indicate that activation of the firmware in the persistent memory module is complete after un-quiescing access to the one or more memory modules of the computing system.

14. The computing system of claim 11, wherein the OS is to resume operation after restoring the saved settings of the one or more I/O devices.

15. The computing system of claim 11, wherein quiescing access to one or more memory modules of the computing system comprises quiescing access to one or more persistent memory modules of the computing system and un-quiescing access to the one or more memory modules of the computing system comprises un-quiescing access to the one or more persistent memory modules of the computing system.

16. The computing system of claim 11, wherein quiescing access to one or more memory modules of the computing system comprises quiescing access to one or more persistent memory modules and one or more primary memory modules of the computing system and un-quiescing access to the one or more memory modules of the computing system comprises un-quiescing access to the one or more persistent memory modules and the one or more primary memory modules of the computing system.

17. The computing system of claim 11 wherein the persistent memory module comprises a three-dimensional cross point memory.

18. A method of updating firmware for a persistent memory module in a computing system comprising:
downloading firmware to the persistent memory module;
saving settings of one or more input/output (I/O) devices of the computing system and setting a timeout value of the one or more I/O devices to greater than a time to activate the firmware in the persistent memory module;
updating the firmware in the persistent memory module during runtime of the computing system by
sending a request to the persistent memory module to activate the firmware after a time delay;
quiescing access to one or more memory modules of the computing system;
waiting for an estimated time; and
un-quiescing access to the one or more memory modules of the computing system; and
restoring the saved settings for the one or more I/O devices.

19. The method of claim 18, comprising:
indicating that quiesce is in progress prior to quiescing access to the one or more memory modules of the computing system; and
indicating that quiesce is complete after un-quiescing access to the one or more memory modules of the computing system.

20. The method of claim 19, comprising:
resuming operation of an operating system (OS) of the computing system after restoring the saved settings of the one or more I/O devices.

21. The method of claim 18, wherein quiescing access to one or more memory modules of the computing system comprises quiescing access to one or more persistent memory modules of the computing system and un-quiescing access to the one or more memory modules of the computing system comprises un-quiescing access to the one or more persistent memory modules of the computing system.

22. The method of claim 18, wherein quiescing access to one or more memory modules of the computing system comprises quiescing access to one or more persistent memory modules and one or more primary memory modules of the computing system and un-quiescing access to the one or more memory modules of the computing system comprises un-quiescing access to the one or more persistent memory modules and the one or more primary memory modules of the computing system.

23. At least one tangible machine-readable non-transitory medium comprising a plurality of instructions that in response to being executed by a processor cause the processor to:
download firmware to a persistent memory module;
save settings of one or more input/output (I/O) devices of the computing system and setting a timeout value of the one or more I/O devices to greater than a time to activate the firmware in the persistent memory module;
update the firmware in the persistent memory module during runtime of a computing system by
sending a request to the persistent memory module to activate the firmware after a time delay;
quiescing access to one or more memory modules of the computing system;
waiting for an estimated time; and
un-quiescing access to the one or more memory modules of the computing system; and
restore the saved settings for the one or more I/O devices.

24. The at least one tangible machine-readable non-transitory medium of claim 23, comprising a plurality of instructions that in response to being executed by the processor cause the processor to:
indicate that quiesce is in progress prior to quiescing access to the one or more memory modules of the computing system; and
indicate that quiesce is complete after un-quiescing access to the one or more memory modules of the computing system.

25. The at least one tangible machine-readable non-transitory medium of claim 24, comprising a plurality of instructions that in response to being executed by the processor cause the processor to resume operation of an operating system (OS) of the computing system after restoring the saved settings of the one or more I/O devices.

26. The at least one tangible machine-readable non-transitory medium of claim 23, wherein instructions to quiesce access to one or more memory modules of the computing system comprise instructions to quiesce access to one or more persistent memory modules of the computing system and instructions to un-quiesce access to the one or more memory modules of the computing system comprise instructions to un-quiesce access to the one or more persistent memory modules of the computing system.
